(19) United States
(12) Patent Application Publication
(10) Pub. No.: US 2012/0308863 A1
(43) Pub. Date: Dec. 6, 2012

(54) WOUND TYPE BATTERY AND METHOD FOR FABRICATING SAME

(76) Inventors: Kenjin Masumoto, Hyogo (JP); Kouji Yamashita, Osaka (JP); Akira Kakinuma, Osaka (JP); Keisuke Yoneda, Osaka (JP)

(21) Appl. No.: 13/519,466

(22) PCT Filed: Dec. 1, 2011
(86) PCT No.: PCT/JP11/06736

§ 371 Date: Jun. 27, 2012

(30) Foreign Application Priority Data
Mar. 16, 2011 (JP) 2011-057549

(51) Int. Cl. H01M 4/00; H01M 6/00

(52) U.S. Cl. 429/94; 29/623.1

(57) ABSTRACT

A battery 1 has a wound body 4 accommodated in a cylindrical battery case 2. The wound body 4 includes an electrode group 6 wound around a core 10. The electrode group 6 includes a negative electrode plate 20, a positive electrode plate 30, and a separator 40. The core 10 is made of a flexible linear conductor, and functions as a negative electrode lead.

### TECHNICAL FIELD

The present invention relates to small-size wound type batteries in a cylindrical shape or a pin shape, and methods for fabricating the wound type batteries.

### BACKGROUND ART

In the wound type batteries, such as lithium-ion secondary batteries, a wound body obtained by rolling an electrode group which includes a negative electrode, a positive electrode, a separator, etc., is accommodated in a battery case. In general, the wound body is formed by winding the electrode group around a rod-like winding core, and removing the winding core thereafter.

There are also batteries whose winding core is not removed but used as a negative electrode lead (see Patent Document 1 and Patent Document 2).

In Patent Document 1, a negative electrode pin having an axial core diameter of 1.5 mm is used as a winding core.

In Patent Document 2, a conductive winding core body including a winding core of even smaller diameter, whose maximum outer diameter is in a range of 0.5 mm or more and 3.0 mm or less, is used as a winding core. As the reason why this range of diameter is preferable, Patent Document 2 explains that “if a conductive winding core body made of stainless steel (SUS) is used, and the maximum outer diameter of the winding core body is less than 0.5 mm, the strength of the winding core body is significantly reduced, and an internal short circuit may be easily caused due to damage in the winding core body such as a curve or a crack (paragraph 0031).”

### CITATION LIST

### Patent Document

[Patent Document 1] Japanese Patent Publication No. 2007-95499
[Patent Document 2] Japanese Patent Publication No. 2005-85556

### SUMMARY OF THE INVENTION

### Technical Problem

In recent years, as wound type batteries (hereinafter also simply referred to as batteries) are becoming smaller in size, there is a demand for further increase in energy density. To increase the energy density of a small battery, the winding core is preferably as small as possible.

However, the stiffness of the winding core is reduced as the diameter of the winding core is reduced. Thus, it is difficult to wind an electrode group around a small-diameter winding core. For this reason, the winding core needs a certain degree of strength, and practically, the diameter of the winding core cannot be smaller than about 1 mm in terms of stability in mass production.

Even if the diameter of the winding core can be reduced to 1 mm, it is difficult to increase the energy density because a space loss relatively increases as the battery size is reduced. For example, in the case of a battery having a diameter of 18 mm, the space loss due to a winding core (cross-sectional comparison) is 4% or so even if the winding core having a diameter of 3.5 mm is used. However, in the case of a smaller battery having a diameter of about 3.5 mm, the space loss due to a winding core is 8% or more even if the winding core having a diameter of 1 mm is used. This means that the effect of space loss is increased.

In view of this, the objective of the present invention is to provide a wound type battery etc. which can be easily reduced in size and of which the energy density can also be improved.

### Solution to the Problem

A battery of the present invention includes a cylindrical battery case having an opening at one end, a sealing member attached to the battery case via an insulating material, for sealing the opening, and a wound body accommodated in the battery case with an electrolyte. The wound body includes a core and an electrode group wound around the core; the electrode group includes a positive electrode plate connected to the sealing member via a positive electrode lead, a negative electrode plate connected to the battery case via a negative electrode lead, and a separator provided between the positive electrode plate and the negative electrode plate.

The core is made of a flexible linear conductor, and functions as the negative electrode lead. For example, a wire may be used as the core.

According to the wound type battery having the above structure, the core is made of a flexible linear conductor, such as a wire. Therefore, the stiffness of the core is insufficient, and the core cannot function as a winding core by itself, unlike winding cores of the conventional batteries of this type.

However, as described later, even a wire etc. can function as a winding core by straining the linear conductor and maintaining the linear conductor in a linear state at the time of winding. Since the diameter of the winding core can be reduced to 1 mm or less, it is possible to reduce the battery in size and improve the energy density.

Moreover, since the core is flexible, it is easy to deform the core. Thus, it is easy to handle the core when the core is used as a negative electrode lead after being used as the winding core. As a result, productivity can be improved.

For example, such a battery can be fabricated by a method including a first step of straining a flexible linear material to maintain the linear material in a strained state in which the linear material is strained by a predetermined tension, and a second step of winding the electrode group around the linear material in the strained state.

According to this fabrication method, the electrode group is wound around the linear material in a strained state. Thus, even a flexible linear material can function as a winding core. Since it is possible to use a linear material whose diameter is smaller than the diameter of conventional materials, the battery can be easily reduced in size, and the energy density can be improved.

Specifically, the second step may include: a first process of fixing the linear material in the strained state to the negative electrode plate orthogonally to a winding direction to form a first connection body having the linear material located at a winding start end of the negative electrode plate; a second process of laying the separator on the first connection body to form a second connection body in which a portion of the first connection body to which the linear material is fixed is connected to the separator; a third process of winding the second connection body around the linear material by rotating the linear material; and a fourth process of placing the positive electrode plate on the second connection body in the middle of the third process to lay the positive electrode plate on the second connection body.

It is preferable to use a linear conductor having electrical conductivity as the linear material. After the second step, a third step of forming the wound body by adjusting a length of an end of the linear conductor to a predetermined length, and a fourth step of inserting the wound body in the battery case, and connecting the end of the linear conductor to an inner surface of the battery case, may be included.

In this case, the linear material may not be removed and used as a negative electrode lead. According to this method, it is possible to prevent the misalignment of the electrode group which tends to occur when the linear material is removed, and possible to reduce the number of fabrication steps because the removal step and an additional step of attaching a current collector lead are not necessary. The number of parts can be advantageously reduced.

For example, it is preferable that a wire is used as the linear conductor, and the linear conductor is connected to the negative electrode plate and the battery case by welding.

According to this method, the electrical connection can be stabler than the electrical connection by adhesion, and the linear conductor can be firmly fixed to the negative electrode plate and the battery case.

### Advantages of the Invention

A battery etc. of the present invention can be easily reduced in size, and the energy density of the battery can also be improved.

### BRIEF DESCRIPTION OF THE DRAWINGS

FIG. 1 is a schematic oblique view of a battery to which the present invention is applied.

FIG. 2 is a schematic view of a cross-section of the battery in FIG. 1.

FIG. 3 is a schematic view of a cross-section taken along the line I-I in FIG. 2.

FIG. 4 is a schematic cross-section showing a basic structure of an electrode group.

FIG. 5 is a flow chart showing basic steps of a method for fabricating the battery.

FIG. 6 is a schematic view for explaining the first step.

FIG. 7 is a schematic view for explaining a process in the second step.

FIG. 8 is a schematic view for explaining a process in the second step.

FIG. 9 is a schematic view for explaining a process in the second step.

FIG. 10 is a schematic view for explaining a process in the second step.

FIG. 11 is a schematic view for explaining a process in the second step.

FIG. 12 is a schematic view for explaining a process in the second step.

FIG. 13 is a schematic view for explaining a process in the third step.

FIG. 14 is a schematic view for explaining a process in the third step.

FIG. 15 is a schematic view for explaining a process in the fourth step.

FIG. 16 is a schematic view for explaining a process in the fourth step.

FIG. 17 is a schematic view of a cross-section of a variation of the battery.

### DESCRIPTION OF EMBODIMENTS

Embodiments of the present invention will be described in detail below based on the drawings. The following embodiments are merely preferred examples in nature, and are not intended to limit the present invention, applications, and use of the invention.

<Wound Type Battery>

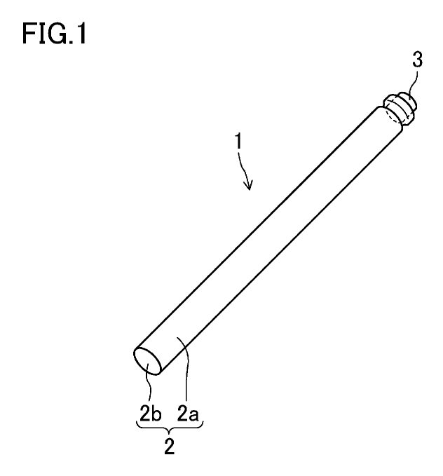

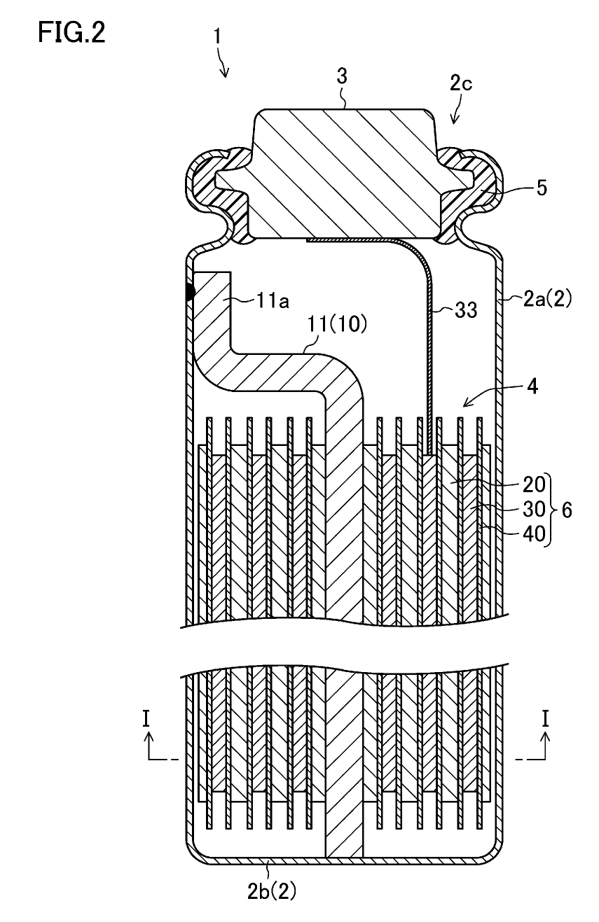

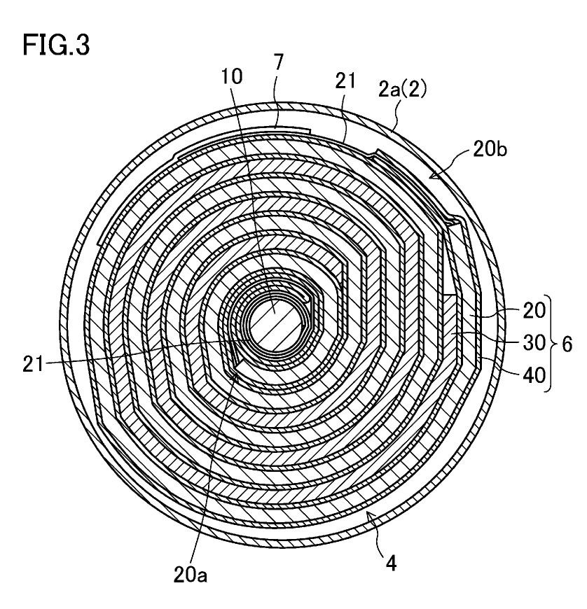

FIG. 1 shows an example battery 1 to which the present invention is applied. The battery 1 is a very small lithium-ion secondary battery (a nonaqueous electrolyte secondary battery) having a pin shape or a cylindrical shape elongated in an axial direction. As shown in detail in FIG. 2 and FIG. 3, the battery 1 includes a battery case 2, a sealing member 3, a wound body 4, etc.

The battery case 2 is a press-molded member made of a metal with superior electrical conductivity. The battery case 2 includes a circumferential wall 2a and a bottom wall 2b, and is formed to be in an elongated cylindrical shape having an opening 2c at one end. The battery case 2 functions also as a negative electrode terminal.

The sealing member 3 is positioned in the opening 2c of the battery case 2, and is fixed to the battery case 2 by crimping the circumferential wall 2a. An insulating gasket 5 is interposed between the battery case 2 and the sealing member 3. The sealing member 3 is also made of a metal member with superior electrical conductivity. The sealing member 3 functions as a positive electrode terminal. The opening 2c is closed by the sealing member 3. Thus, the inner space of the battery case 2 is enclosed. The battery case 2 or the sealing member 3 may be provided with a safety valve which is opened when the internal pressure exceeds a predetermined pressure.

In the enclosed inner space of the battery case 2, an electrolyte (not shown) and the wound body 4 are accommodated. In the present embodiment, a nonaqueous organic electrolyte is used as the electrolyte. The wound body 4 is comprised of a core 10, an electrode group 6 wound around the core 10, etc. The electrode group 6 is comprised of a negative electrode plate 20, a positive electrode plate 30, a separator 40, etc.

The core 10 is made of a flexible metal wire (an example linear conductor) which is easily bent, with superior electrical conductivity. The core 10 is also used as a winding core. Thus, as described later, the core 10 is strained strongly to remain in a linear shape. Accordingly, it is preferable that the core 10 has superior tensile strength, and is not much extended by a tension. For example, the core 10 is preferably made of a wire whose modulus of longitudinal elasticity (see the HS specification) is 150 GPa or more. Specifically, piano wires, stainless wires, hard steel wires, etc., may be used as the core 10. Metal wires are advantageous in that they can be welded.

It is preferable that the diameter (the outer diameter) of the core 10 is small. This is because the smaller the diameter of the core 10, the more amount of the electrode group 6 or the electrolyte can be accommodated in the battery case 2. As a result, the energy density can be improved. In the case of the battery 1, the diameter of the core can be reduced to 1 mm, which is a threshold value in the conventional cores, or less. The diameter of the core 10 is preferably in a range of 0.2-0.5 mm in terms of practical use.

The core 10 does not only function as a winding core, but also functions as a negative electrode lead. Specifically, the core 10 is located between the negative electrode plate 20 and the battery case 2 to electrically connect the negative electrode plate 20 and the battery case 2. The arrangement of the core 10 will be described later.

The negative electrode plate 20, the positive electrode plate 30, and the separator 40 are strap-like sheets whose widths are approximately the same. The sheets are layered and rolled to form the electrode group 6. Thus, the negative electrode plate 20 and the positive electrode plate 30 preferably have properties superior in flexibility.

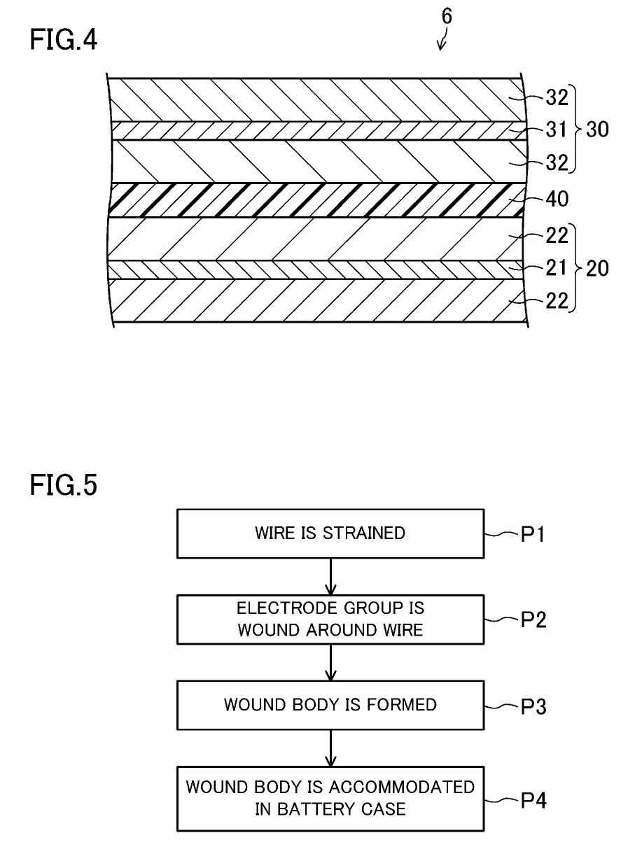

FIG. 4 shows a structure of the electrode group 6. The negative electrode plate 20 includes a negative electrode current collector 21 and a pair of negative electrode active layers 22, 22 formed on both surfaces of the negative electrode current collector 21. The positive electrode plate 30 includes a positive electrode current collector 31 and a pair of positive electrode active layers 32, 32 formed on both surfaces of the positive electrode current collector 31. The separator 40 made of resin is provided between the negative electrode plate 20 and the positive electrode plate 30 to insulate the negative electrode plate 20 and the positive electrode plate 30 from each other.

Examples of the material for the negative electrode current collector 21 include a thin film made of copper, stainless steel, nickel, etc. For example, a copper foil can be used as the negative electrode current collector 21. The negative electrode active layer 22 includes a negative electrode active material, a binder, a conductive agent, etc. Examples of the negative electrode active material include black lead, carbon materials such as carbon fiber, silicon compounds such as SiOₓ etc.

Examples of the binder include polyvinylidene fluoride (PVDF), PVDF derivatives, and rubber-based binders (e.g., fluoro rubber, acrylic rubber, etc.). Examples of the conductive agent include graphites such as black lead, carbon blacks such as acetylene black, etc.

Examples of the material for the positive electrode current collector 31 include a thin film made of aluminum, stainless steel, titanium, etc. The positive electrode active layer 32 includes a positive electrode active material, a binder, a conductive agent, etc. Examples of the positive electrode active material include a lithium-containing composite metal oxide, such as LiCoO₂, LiNiO₂, LiMnO₂, LiCoNiO₂, etc. The same materials for the binder and the conductive agent in the negative electrode active layer 22 can be used as the materials for the binder and the conductive agent.

The negative electrode plate 20 is formed by applying a material for the negative electrode active layer 22 in the form of slurry on the surface of the negative electrode current collector 21, and thereafter drying the negative electrode active layer 22 and rolling the negative electrode current collector 21 with the dried negative electrode active layer 22. The positive electrode plate 30 is formed in a similar manner as the negative electrode plate 20.

As shown in FIG. 3, the negative electrode current collector 21 protrudes in a winding direction from one end (the winding start end 20a) of the negative electrode plate 20 and the other end (the winding termination end 20b) of the negative electrode plate 20 in a circumferential direction. The negative electrode current collector 21 protruding from the winding start end 20a is individually wound around the core 10 a plurality of times. The negative electrode current collector 21 and the core 10 are connected by welding.

As shown in FIG. 2, one end of the core 10 in the axial direction (the end closer to the opening 2c of the battery case 2) has a predetermined length protruding from the electrode group 6 and forming a negative electrode lead (also referred to as a lead end 11). The tip of the lead end 11 is curved to be provided approximately on an extended surface of the outer circumferential surface of the electrode group 6 (the tip is also referred to as a connection end 11a). The connection end 11a is connected to an inner surface of the circumferential wall 2a by resistance welding.

The other end of the core 10 (the end closer to the bottom of the battery case 2) has a length that does not obstruct accommodation in the battery case 2. In the present embodiment, this end slightly protrudes from the electrode group 6.

As shown in FIG. 3, the negative electrode current collector 21 protruding from the winding termination end 20b of the negative electrode plate 20 protrudes more in the winding direction than the positive electrode plate 30 and the separator 40. Fixing tape 7 is adhered to the outermost circumferential surface of the electrode group 6 to overlap with this portion of the negative electrode current collector 21. The rolled shape of the electrode group 6 is maintained by the fixing tape 7.

The length of the positive electrode plate 30 in the winding direction is shorter than the length of the negative electrode plate 20. As shown in FIG. 2, a positive electrode lead 33 continuously extending from the positive electrode current collector 31 protrudes from a predetermined portion of one side of the positive electrode plate 30 in the axial direction (the side closer to the opening 2c of the battery case 2). The positive electrode lead 33 may be part of the positive electrode current collector 31 or may be a different member. The positive electrode lead 33 has a strip-like shape having a predetermined length. The tip of the positive electrode lead 33 is connected to the inner surface of the sealing member 3, thereby electrically connecting the negative electrode plate 20 and the sealing member 3.

<Method for Fabricating Wound Type Battery>

As shown in FIG. 5, a method for fabricating the battery 1 includes, for example, the first step P1 in which a wire to be the core 10 is strained and used as a winding core, the second step P2 in which the electrode group 6 is wound around the strained wire, the third step P3 in which an end of the wire is adjusted for the use as a negative electrode lead, thereby forming the wound body 4, and the fourth step P4 in which the wound body 4 is accommodated in the battery case 2. For example, these steps are successively performed using a dedicated device.

(First Step)

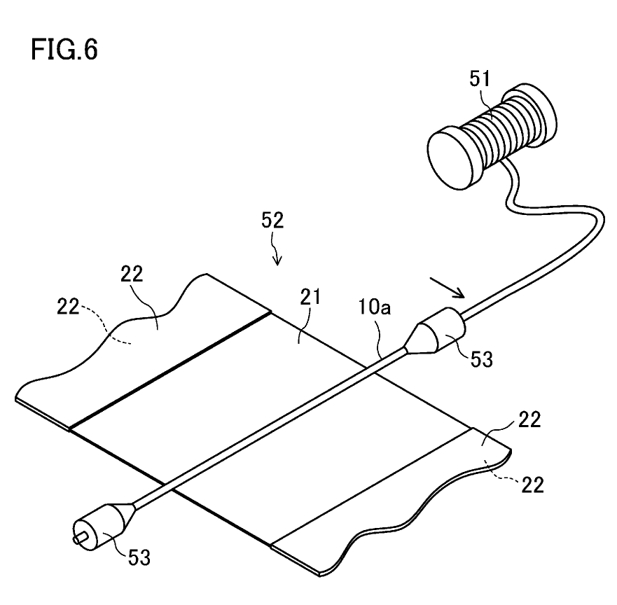

In the first step P1, a portion to be used as the core 10 (referred to as a core wire 10a) is pulled out from a wire roll 51 as shown in FIG. 6. A negative electrode plate base 52 to be the negative electrode plate 20 is prepared. The negative electrode plate base 52 is like the negative electrode plates 20 continuously placed in series. The negative electrode active layers 22 are provided on both surfaces of the strip-like negative electrode current collector 21 capable of being rolled, so as to oppose each other at a predetermined interval. A predetermined portion of the negative electrode plate base 52 is cut off to obtain the negative electrode plate 20. The core wire 10a is positioned on a portion of the negative electrode plate base 52 where the negative electrode current collector 21 is exposed.

The both end portions of the core wire 10a are supported by a pair of clamps 53, 53. The core wire 10a is strained until a predetermined tension is applied, and is held by the clamps 53 so that the strained state can be maintained. As a result, the flexible core wire 10a can be maintained in a linear shape, and serve as a winding core. The wire is cut, for example, at a portion indicated by the arrow shown in FIG. 6, thereby separating the core wire 10a from the wire roll 51.

(Second Step)

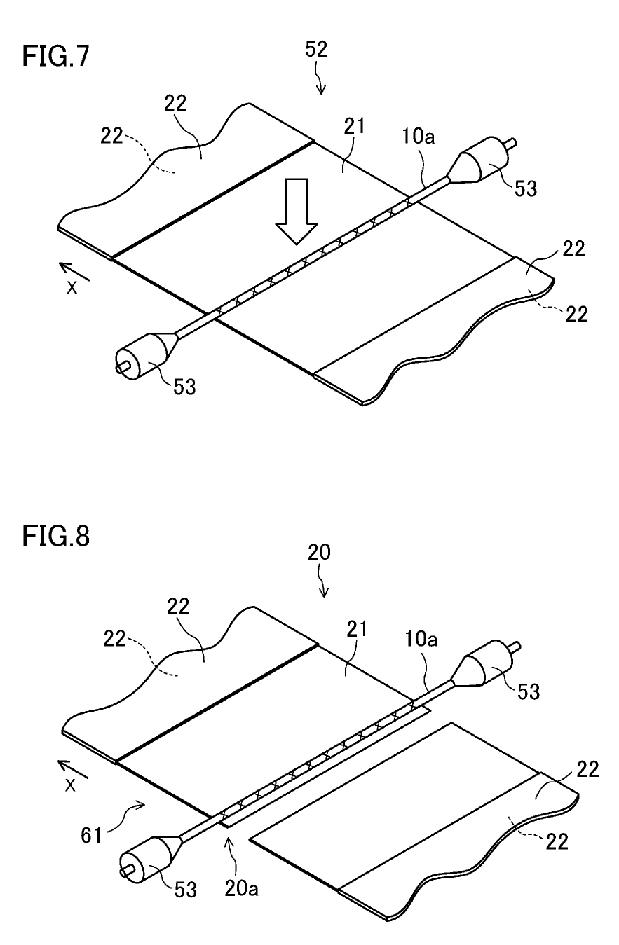

First, in the second step P2, the core wire 10a and the negative electrode plate 20 are connected to each other as shown in FIG. 7 (the first process). Specifically, the core wire 10a is positioned orthogonal to a longitudinal direction of the negative electrode plate base 52 (i.e., the winding direction indicated by arrow X in FIG. 7). As indicated by the open arrow, the core wire 10a is pressed against the negative electrode current collector 21, and the core wire 10a and the negative electrode current collector 21 are connected to each other by resistance welding, laser beam welding, ultrasonic welding, etc.

Then, as shown in FIG. 8, the negative electrode current collector 21 is cut or melt-cut along the core wire 10a near the portion at which the core wire 10a is connected. As a result, a first connection body 61 in which the core wire 10a is positioned and fixed at the end (the winding start end 20a) of the negative electrode plate 20 is obtained.

The core wire 10a may be connected to the negative electrode current collector 21 after the negative electrode current collector 21 is separated from the negative electrode plate base 52. However, in view of productivity, it is preferable to connect the core wire 10a to the negative electrode current collector 21 before cutting because the negative electrode current collector 21 is a thin film.

In the end of the first process, it is preferable to wind part of the negative electrode current collector 21 around the core wire 10a at low load (a temporary connection process). If the core wire 10a has a small diameter, it results in a small connection area, and the connection strength can be easily reduced. Since tension is applied to the connecting portion during winding, the core wire 10a may be broken or detached from the negative electrode current collector 21, depending on conditions.

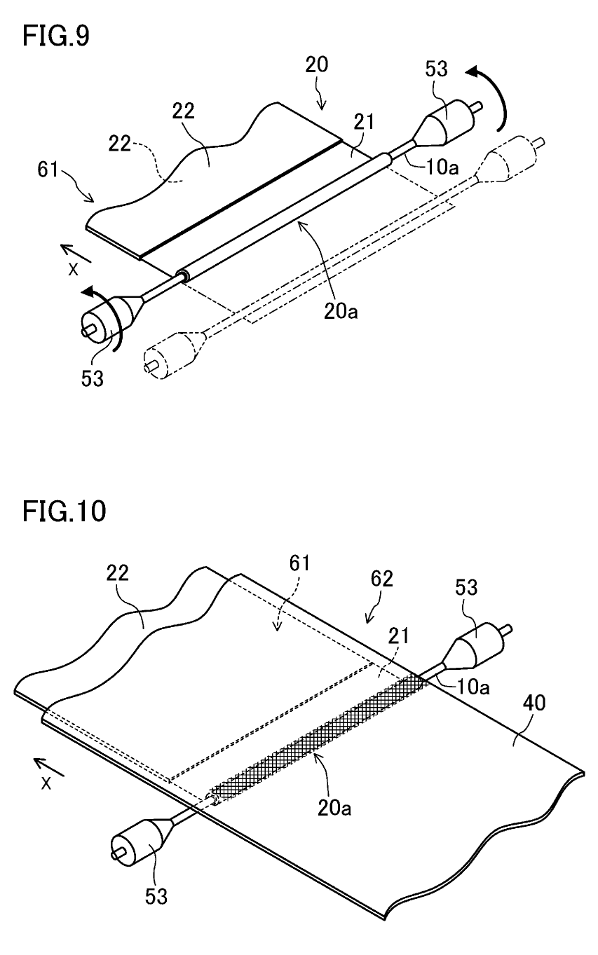

To avoid these problems, part of the negative electrode current collector 21 is wound around the core wire 10a a plurality of times at load lighter than the tension applied during winding (i.e., at no load or low load) as shown in FIG. 9 to ensure stable winding. Consequently, the negative electrode current collector 21 is wound around the core wire 10a, and the negative electrode current collector 21 cannot be easily separated from the core wire 10a.

Next, the first connection body 61 and the separator 40 are connected to each other (the second process). Specifically, the separator 40 is prepared and positioned on the first connection body 61 as shown in FIG. 10. In the case of the separator 40, too, the separator 40 may be obtained by cutting off a predetermined portion of a member including separators 40 continuously placed in series.

The separator 40 is laid on the first connection body 61. The portion of the first connection body 61 to which the core wire 10a is connected is connected to the separator 40 by thermal welding. The thermal welding portion is in the middle of the separator 40 in the longitudinal direction (i.e., the winding direction). Specifically, part of the separator 40 protrudes from the winding start end 20a of the first connection body 61 in a direction opposite to the winding direction.

As a result, a second connection body 62 in which the separator 40 is positioned and fixed to the first connection body 61 is obtained.

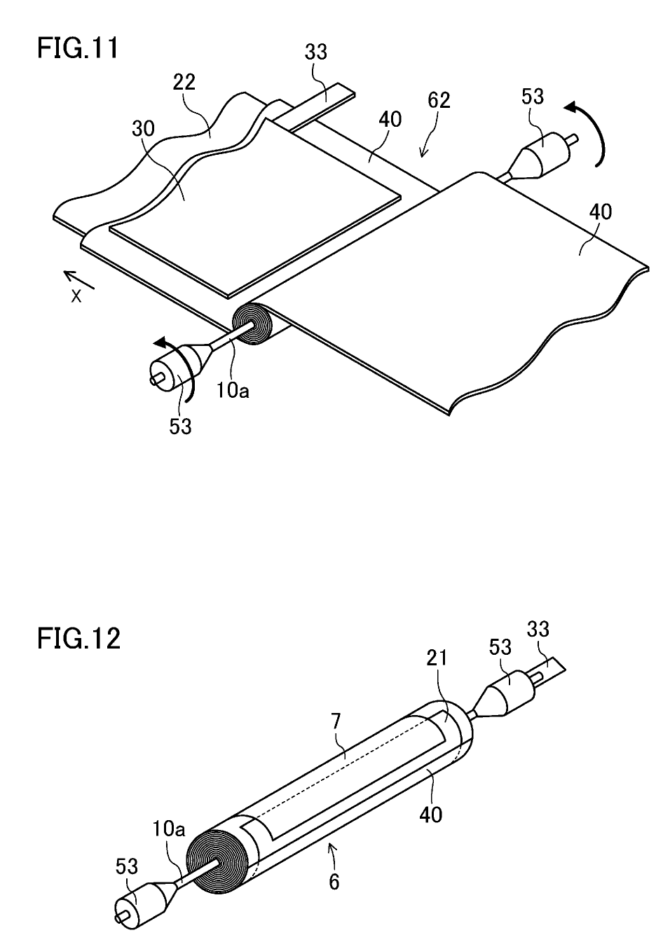

Next, as shown in FIG. 11, the second connection body 62 is wound (the third process). Specifically, the core wire 10a is rotated such that the separator 40 comes inside, thereby winding the second connection body 62 around the core wire 10a.

In the middle of the third process, a positive electrode plate 30 is laid on the second connection body 62 (the fourth process). Specifically, the positive electrode plate 30 is placed on a predetermined portion of the second connection body 62 on the side to which the separator 40 is provided. The core wire 10a is further rotated, with the positive electrode plate 30 placed on the separator 40.

By winding all of the components such as the separator 40, the negative electrode plate 20 and other components are rolled as shown in FIG. 12. As a result, the electrode group 6 having a multilayer cross-section as shown in FIG. 3 can be obtained. Lastly, the fixing tape 7 is adhered to the outermost circumferential surface of the electrode group 6 to maintain the rolled shape.

(Third Step)

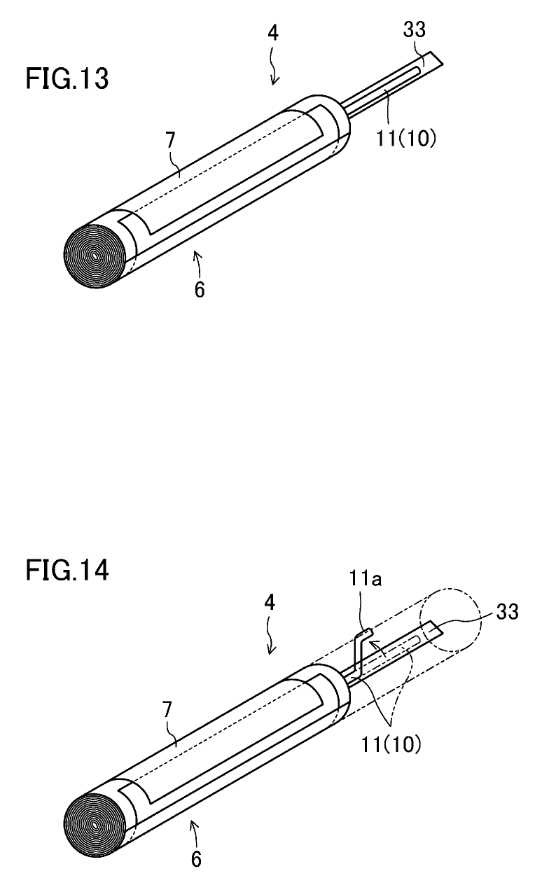

As shown in FIG. 13, in the third step P3, the length of the end of the core wire 10a is adjusted to form the core 10. Specifically, the electrode group 6 etc. is detached from the clamps 53 etc. The end of the core wire 10a on the same side as the positive electrode lead 33 is cut into a predetermined length. This end is used as the lead end 11. The other end of the core wire 10a is cut into a length that does not obstruct accommodation in the battery case 2. As a result, the wound body 4 is obtained.

Next, as shown in FIG. 14, the lead end 11 is bent to form the connection end 11a. Specifically, the tip of the lead end 11 is bent into an L shape, and the tip is positioned approximately on the extended surface of the outer circumferential surface of the electrode group 6.

(Fourth Step)

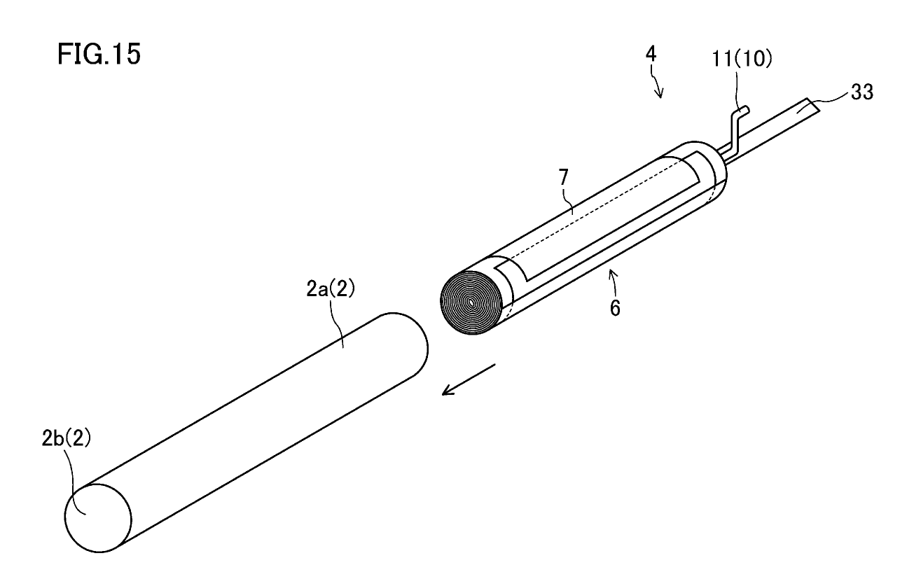

In the fourth step P4, the wound body 4 is inserted in the battery case 2, and the lead end 11 is connected to the battery case 2. Specifically, as shown in FIG. 15, the wound body 4 is inserted in the battery case 2 from the side from which no lead end 11 and no positive electrode lead 33 protrude, and is positioned at a predetermined location in the battery case 2. The connection end 11a of the lead end 11 comes in contact with the inner surface of the circumferential wall 2a of the battery case 2, or positioned close to the inner surface.

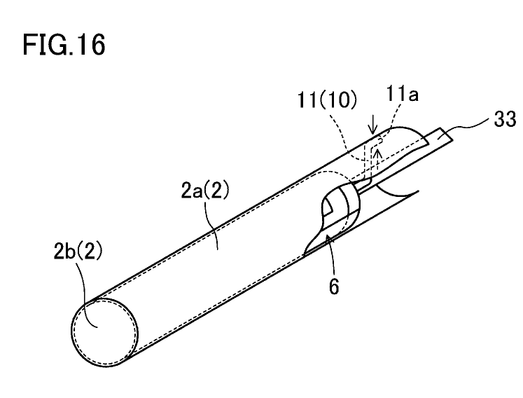

Then, as indicated by the arrows in FIG. 16, the circumferential wall 2a and the connection end 11a are held in both the inward and outward radial directions, thereby press fitting the connection end 11a to the circumferential wall 2a. The connection end 11a is connected to the inner surface of the circumferential wall 2a by resistance welding, etc.

After that, processes such as connecting the positive electrode lead 33 to the sealing member 3, and filling the battery case 2 with an electrolyte are performed. Lastly, the circumferential wall 2a is crimped to fix the sealing member 3 to the battery case 2. As a result, the opening 2c is closed.

A wound type battery etc., according to the present invention is not limited to the above embodiment, and includes various structures other than the structures described in the above embodiment.

For example, the wire used as the core 10 is used also as a negative electrode lead in the fabrication method described in the above embodiment, but the wire used as the core 10 may be removed after the winding of the electrode group 6. The space loss can be reduced in this case, too. Thus, even if a battery is reduced in size, it is possible to improve the energy density.

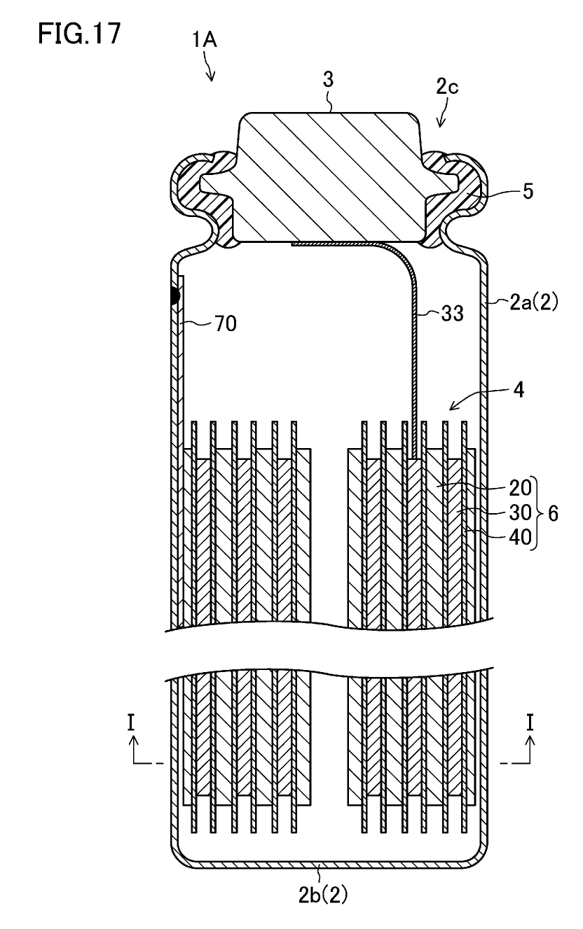

An example of such a battery is shown in FIG. 17 (indicated by the reference character 1A). In this case, a negative electrode lead (indicated by the reference character 70 in FIG. 17) can be provided, for example, at the winding termination end 20b of the negative electrode plate 20 (i.e., at a portion of the negative electrode current collector 21) located at the outermost layer of the electrode group 6, similar to the positive electrode lead 33.

The present invention may be applied not only to secondary batteries, but also to primary batteries. Materials for the batteries are also not limited to lithium. That is, the present invention can be applied to any batteries in which an electrode group is wound. The linear conductor is not limited to a metal wire. For example, a carbon wire or a composite wire having electrical conductivity may be used.

The connection between the core 10 and the negative electrode plate 20, etc. and the connection between the first connection body 61 and the separator 40 are not limited to welding and thermal welding, but may be adhesion or press fitting, etc. Alternatively, these connections may be achieved by fixing by tape or fixing by lapping (for example, the separator 40 may be folded by 180° to lap around the winding start end 20a of the first connection body 61), etc.

### DESCRIPTION OF REFERENCE CHARACTERS

1 battery
2 battery case
2c opening
3 sealing member
4 wound body
5 gasket (insulating material)
6 electrode group
10 core
10a core wire
20 negative electrode plate
30 positive electrode plate
33 positive electrode lead
40 separator
61 first connection body
62 second connection body

1. A wound type battery, comprising:
a cylindrical battery case having an opening at one end;
a sealing member attached to the battery case via an insulating material, for scaling the opening; and
a wound body accommodated in the battery case with an electrolyte, wherein
the wound body includes
a core, and
an electrode group wound around the core,
the electrode group includes
a positive electrode plate connected to the sealing member via a positive electrode lead,
a negative electrode plate connected to the battery case via a negative electrode lead, and
a separator provided between the positive electrode plate and the negative electrode plate, and
the core is made of a flexible linear conductor, and functions as the negative electrode lead.

2. The wound type battery of claim 1, wherein
a wire is used as the core.

3. The wound type battery of claim 1, wherein
one end of the core protrudes from the electrode group, and
the one end is bent to be fixed to an inner surface of the battery case.

4. The wound type battery of claim 1, wherein
the core has a diameter of 1 mm or less.

5. The wound type battery of claim 1, wherein
a nonaqueous organic electrolyte is used as the electrolyte, and the wound type battery functions as a secondary battery.

6. A method for fabricating a wound type battery having a wound body in which an electrode group is wound, the method comprising:
a first step of straining a flexible linear material to maintain the linear material in a strained state in which the linear material is strained by a predetermined tension, and
a second step of winding the electrode group around the linear material in the strained state.

7. The method for fabricating the wound type battery of claim 6, wherein
the electrode group includes a positive electrode plate, a negative electrode plate, and a separator provided between the positive electrode plate and the negative electrode plate, and
the second step includes
a first process of fixing the linear material in the strained state to the negative electrode plate orthogonally to a winding direction to form a first connection body having the linear material located at a winding start end of the negative electrode plate,
a second process of laying the separator on the first connection body to form a second connection body in which a portion of the first connection body to which the linear material is fixed is connected to the separator,
a third process of winding the second connection body around the linear material by rotating the linear material, and
a fourth process of placing the positive electrode plate on the second connection body in the middle of the third process to lay the positive electrode plate on the second connection body.

8. The method for fabricating the wound type battery of claim 7, wherein
the wound type battery includes a cylindrical battery case which has an opening at one end and which accommodates the wound body,
the wound body includes the linear material,
a linear conductor having electrical conductivity is used as the linear material, and
the method includes
after the second step, a third step of forming the wound body by adjusting a length of an end of the linear conductor to a predetermined length, and
a fourth step of inserting the wound body in the battery case, and connecting the end of the linear conductor to an inner surface of the battery case.

9. The method for fabricating the wound type battery of claim 8, wherein
a wire is used as the linear conductor, and
the linear conductor is connected to the negative electrode plate and the battery case by welding.

10. The method for fabricating the wound type battery of claim 7, wherein
the first process includes a temporary connection process in which part of the negative electrode plate is wound around the linear material, with a tension applied to the negative electrode plate being lower than a tension applied to the negative electrode plate during winding.

11. A wound type battery fabricated by the fabrication method of claim 6.
